(19) United States
(12) Patent Application Publication
(10) Pub. No.: US 2016/0108607 A1
(43) Pub. Date: Apr. 21, 2016

(54) Water Pump Pressure Switch Providing Automatic Power Shut-Off To A Well Pump

(71) Applicant: Tec Innovators Water Control Products, LLC, Amherst, NH (US)

(72) Inventor: Donald WEINSTEIN, Amherst, NH (US)

(21) Appl. No.: 14/886,459

(22) Filed: Oct. 19, 2015

Related U.S. Application Data
(60) Provisional application No. 62/065,253, filed on Oct. 17, 2014.

(51) Int. Cl. E03B 5/06; H01H 35/26; H01H 50/64; E03B 3/08

(52) U.S. Cl. CPC E03B 5/06; E03B 3/08; H01H 35/2671; H01H 50/64

(57) ABSTRACT

A water pump pressure switch that is adapted to provide a system for automatic power shut-off to the well pump. The water pump pressure switch is specifically adapted to provide such feature by incorporation of additional components such as an electromechanical solenoid that upon receipt of a signal engages with a lift bar which opens electrical contacts, disrupts power feed to the well pump, sounds an audio alarm or sends a signal to a house alarm or a wireless device.

### CROSS-REFERENCE TO RELATED APPLICATIONS

This application claims the benefit of U.S. Provisional Patent Application Ser. No. 62/065,253, filed on Oct. 17, 2014, which is fully incorporated herein by reference.

### FIELD

The present invention relates to a water pump pressure switch that is adapted to provide a system for automatic power shut-off to the well pump. The water pump pressure switch is specifically adapted to provide such feature by incorporation of additional components into the pressure switch such as an electromechanical solenoid that upon receipt of a signal engages with a lift bar which opens electrical contacts, disrupts power feed to the well pump, sounds an audio alarm or sends a signal to a house alarm or a wireless device.

### BACKGROUND

Conventional domestic well water supply systems almost universally comprise a pump driven by a constant speed electric motor. The pump intake is located in the water reservoir of the well, its outlet delivering the water output to the inlet of a pressure tank. The tank inlet is located near its bottom as is its outlet, which is connected in flow communication to the main water supply pipe of the residence or other facility to be provided with a supply of running water. The tank inlet and outlet are located in the lower end of the tank in order that the upper portion can contain a captive volume of air which is compressed as water is forced into the tank inlet by the well pump.

A pressure switch controls the motor in response to the pressure accumulated in the tank. The pressure switch has high/off and low/on limit switches, usually adjustable, so that when the pressure reaches a preset upper limit the pump stops and remains off until pressure in the tank falls below the lower limit due to water consumption, at which time the pump starts and continues in operation until the pressure is restored to the upper limit. While various refinements have been made over the years the use of bladders within the pressure tank to prevent loss of the air head (water-logging), the basic system has remained unchanged.

A water leak can, of course, result in considerable damage to the home environment. Various consumer products are offered to deal with such a problem, including sump pumps, basement waterproofing efforts, etc. However, while these systems can deal with some aspect of a water leak, the problem remains that such systems do not address the need to stop power at the well pump.

A need therefore remains for a water leak detection system that would remove power from the well pump in the event of a water leak or a signal from an alarm or wireless system. In addition, a need exists for a system that would allow for relative ease of installation and which could avoid the need for a separate external power source. That is, the need exists for a system that would readily make use of the power source for the well pump (120 VAC) or use a wall plug power transformer. In addition, a need remains for a system that can be readily installed by plumbers when servicing a well-pump and in particular, the installation or servicing of a well-pump pressure switch.

### SUMMARY

The present disclosure relates to a method for configuring a water pump pressure switch to provide for water leak detection and shut down of a water well pump. The method begins with supplying a water pump pressure switch which is configured to allow for electrical power to be delivered to the water well pump as a function of a preset pressure limit wherein the pressure switch has an original housing volume (Vo). This is then followed by incorporating a water leak detection system into the water pump pressure switch wherein the leak detection system responds to water detection and provides shut-down of the water well pump wherein said original housing volume (Vo) is increased to a housing volume maximum of equal to or less than 2(Vo) to accommodate the leak detection system. The water leak detection system may optionally provide an output signal to a house alarm or a wireless device.

The present disclosure in system form relates to a leak detection system for a well pump comprising a well pump pressure switch having a housing containing electrical contacts which in a closed position are configured to provide for delivery of electrical power to the well pump and in an open position are configured to prevent electrical power from being delivered to the well pump. The system includes one or a plurality of water detectors capable of providing a signal upon detection of water and an electromechanical servo within the housing and in communication with the one or more of the water detectors or an external alarm signal. A lift bar is provided and is engaged with the electromechanical servo within the pressure switch housing wherein the electromechanical servo is capable of activating the lift bar to engage and open the electrical contacts upon receipt of a signal from the one or more water detectors or an external alarm signal.

The present disclosure also relates to a water pump pressure switch for a well pump configured to respond to a signal from one or more water detectors or an external alarm signal comprising a housing containing electrical contacts which in a closed position are configured to provide for delivery of electrical power to the well pump and in an open position are configured to prevent electrical power from being delivered to the well pump. The pressure switch also contains a lift bar capable of opening and closing the electrical contacts and an electromechanical servo engaged to the lift bar wherein said wherein said electromechanical servo is capable of activating the lift bar to engage and open the electrical contacts upon receipt of a signal from the one or more water detectors or an external alarm signal.

### BRIEF DESCRIPTION OF THE DRAWINGS

FIG. 1 illustrates a typical well installation.

FIG. 2 illustrates a perspective view of the pressure switch housing adapted to provide automatic power shut-off to a well tank.

FIG. 3 illustrates a cross-sectional view along line A-A of FIG. 2.

FIG. 4 illustrates a cross-sectional view along line B-B of FIG. 2 where the pressure switch is in its normal operating mode.

FIG. 5 illustrates a cross-sectional view along lines B-B of FIG. 2 where the pressure switch is in the actuated position.

FIG. 6 illustrates one example of a water pump pressure switch that may be modified herein to provide for water leak detection and/or shutoff power to the water well pump.

FIG. 7 illustrates another example of a water pump pressure switch that may be modified herein to provide for water leak detection and/or shutoff power to the water well pump.

### DETAILED DESCRIPTION

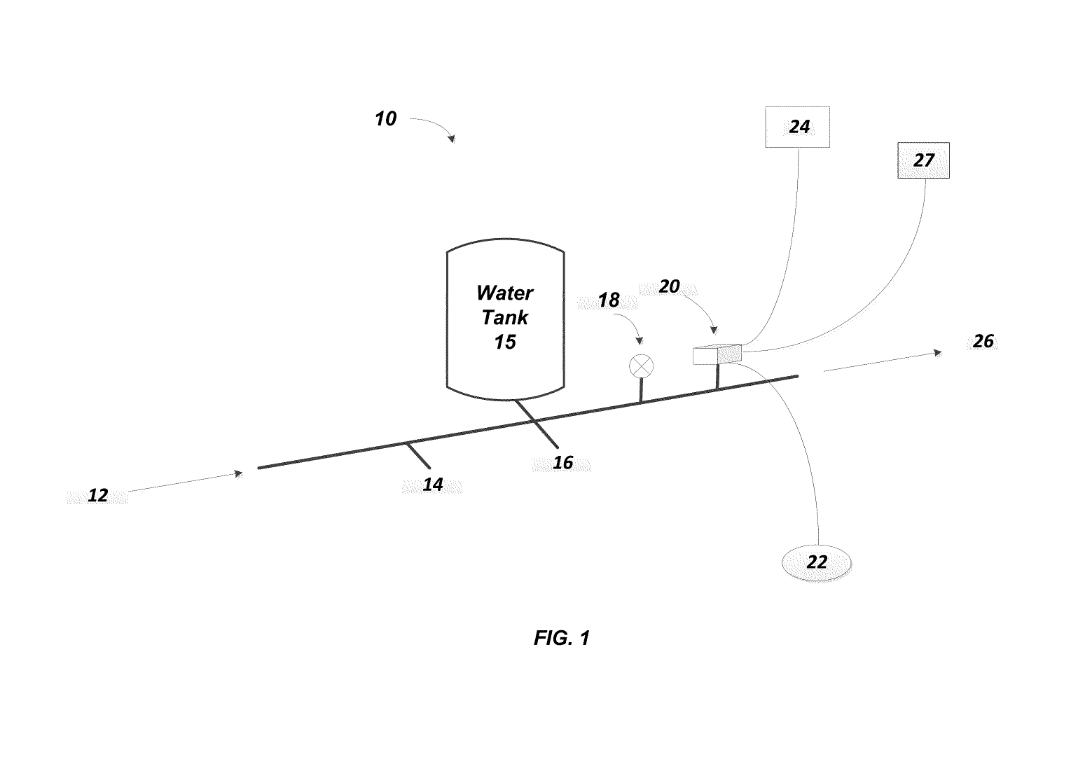

FIG. 1 illustrates a typical well installation 10 for the pressure switch of the present invention. As illustrated a water supply from a well 12 may be fed to such well installation which can include a hand valve 14 and water tank 15 that may include a water relief valve at 16. A pressure gage is shown at 18 and the pressure switch at 20. The pressure switch may be in communication with one or more water detectors 22 which can be placed at strategic locations, such as on the floor surrounding the well installation, or at any location where a water leak may be possible. The pressure switch may also be in communication with a house alarm or a wireless sending device. One preferred water detector 22 is available as the WET SWITCH™ from DiversiTech, Deluth, Ga. The water detectors and/or the alarm or wireless device 27 may therefore provide a signal to the pressure switch 20 which will trigger the pressure switch into an off mode that disrupts power to the well pump from the well pump power switch 24. As shown, water supplied to the house from the well pump will flow in the direction of arrow 26.

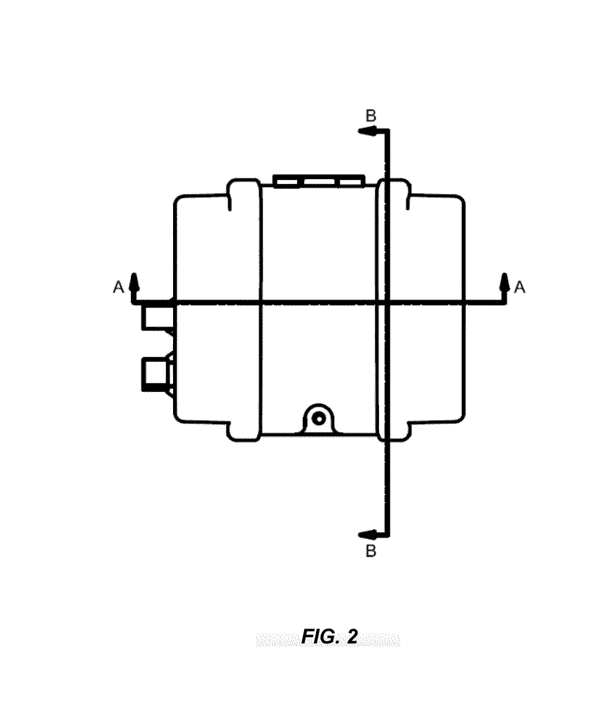

The pressure switch 20 herein may be selected from any standard type pressure switch, wherein the switch operates to set an upper limit of pressure where the pump stops and remains off until pressure in the tank falls below a pressure lower limit, at which time the pump starts and continues in operation until the pressure is restored to the upper limit. The invention herein is such that it makes efficient use of the available space within the pressure switch housing such that it may be uniquely employed to include an automatic shut-off mechanism to shut-down the well pump. Accordingly, any water leak may be promptly shut-down at the source, thereby mitigating water damage in the most effective manner possible. One non-limiting example of such a pressure switch is illustrated in FIG. 2, which is a perspective view of the pressure switch housing.

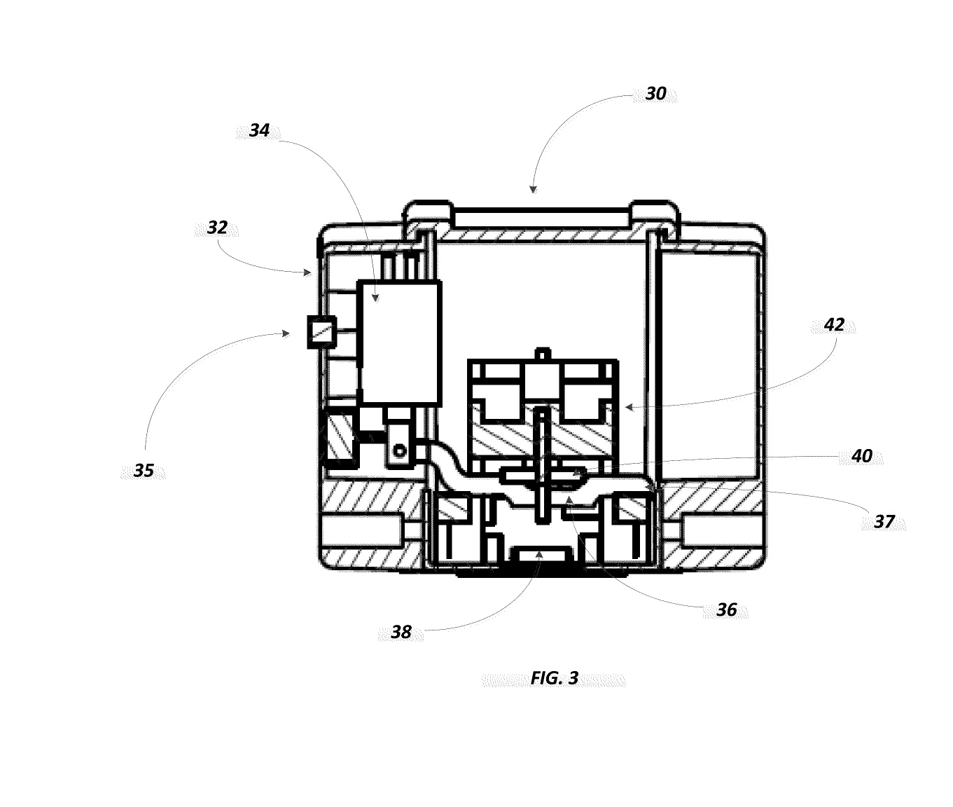

FIG. 3 provides a cross-sectional view along line A-A of FIG. 2. As can be seen, the pressure switch contains a pressure switch cover 30 which is engaged with the pressure switch housing 32. The pressure switch cover and pressure switch housing are of the same general shape as the original pressure switch cover and housing, but now are configured to define a relatively greater volume to accommodate an electromechanical solenoid 34 which is engaged to a lift bar 36. The pressure switch lift plate is shown at 38 along with contact lift plate 40. The contact housing is shown at 42. The lift bar 36 is in the unactuated position and is configured such that it may pivot at location 37. That is, the pressure switch in FIG. 3 is operating in its normal intended manner such that it will control the well pump motor and respond to changes in line pressure.

The electromechanical solenoid 34 is itself in communication with a house alarm or wireless device 27 (FIG. 1) and/or one or a plurality of water leak sensors 22 (FIG. 1) such that upon detection of water as explained more fully herein, the pressure switch will shut off well pump power. The electromechanical solenoid may be in communication with a house alarm or wireless device and/or such water leak sensors 22 through connection location 35, which may also be employed to introduce power to the solenoid. It therefore can be appreciated from FIG. 3 that by incorporating an electromechanical solenoid and lift bar into the pressure switch, a highly convenient modification of the original pressure switch can now be implemented. As alluded to above, the incorporation of such components within the pressure switch may require that the original pressure switch housing is enlarged. If one therefore considers that the original pressure switch cover and housing define an original pressure switch housing volume (Vo), the increase in the size of the pressure switch cover and/or pressure switch housing is less than or equal to 100%, more preferably, less than or equal to 60%. That is, the pressure switch housing volume may increase in size up to less than or equal to twice its original volume (2(Vo)). More preferably, the pressure switch housing volume may increase in size up to less than or equal to 1.6 times its original volume (1.6(Vo)).

Accordingly, it may be appreciated that the pressure switch housing volume may be preferably increased in volume of, e.g, 15% to 100% (1.15(Vo) to 2.0(Vo)) and more preferably 15% to 60% of its original volume (1.15(Vo) to 1.6(Vo)) to accommodate the leak detection components noted above (electromechanical servo and lift bar). Most preferably, the increase in volume is in the range of 25% to 55% (1.25(Vo) to 1.55(Vo)).

Stated another way, one may now start with a conventional well pump pressure switch of any general type and incorporate an electromechanical solenoid and lift bar which is then configured to be in communication with a house alarm or wireless device and/or one or more water leak sensors 22, and powered by existing available power (no external power source is required) or a wall plug type power transformer. By incorporating such features into the pressure switch housing volume, where the pressure switch housing does not increase by more than twice its original volume, and more preferably, only increases up to about 1.6 times its original volume, the pressure switch offers the ability to provide leak detection which can be readily installed by those who are familiar with general well pump pressure switch installation.

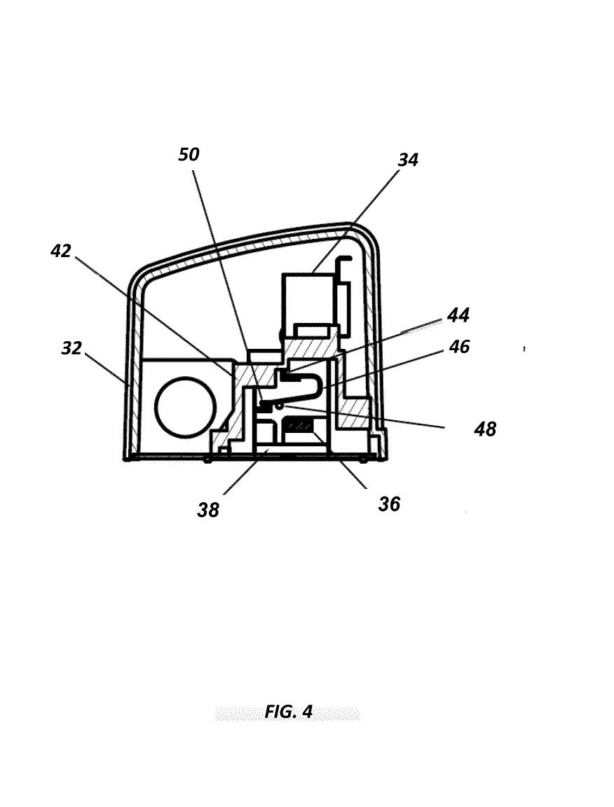

FIG. 4 provides a section view along lines B-B of FIG. 2. FIG. 4 illustrates the pressure switch in the unactuated position. As before, the pressure switch includes a pressure switch housing 32, lift bar 36 in the unactuated position and pressure switch lift plate 38. Also one can see the upper contact connection at 44, the contact spring bar 46 and the contact lift plate 48. The main contacts are shown at 50 and are in a closed position, such that the pressure switch is in its normal operating mode.

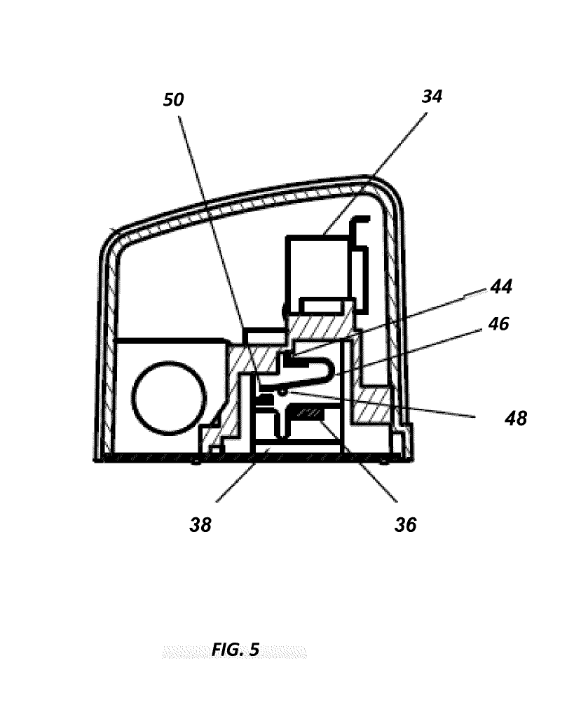

FIG. 5 provides another section view along lines B-B of FIG. 2 where the pressure switch is now in the actuated position. More specifically, when the electromechanical solenoid receives a signal from a house alarm or wireless device and/or a water detection sensor signaling that water is present, it will lift the lift bar 36 which will then exert an upward force on contact lift plate 48 thereby causing the main contacts to an open position. This in turn shuts-off power to the well pump so that water is no longer supplied within the water lines of a given installation.

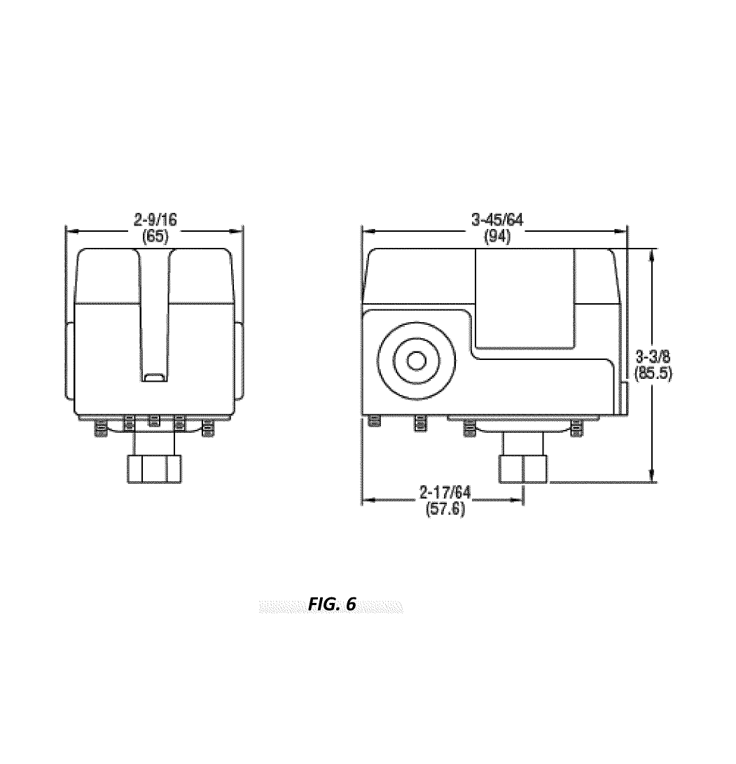

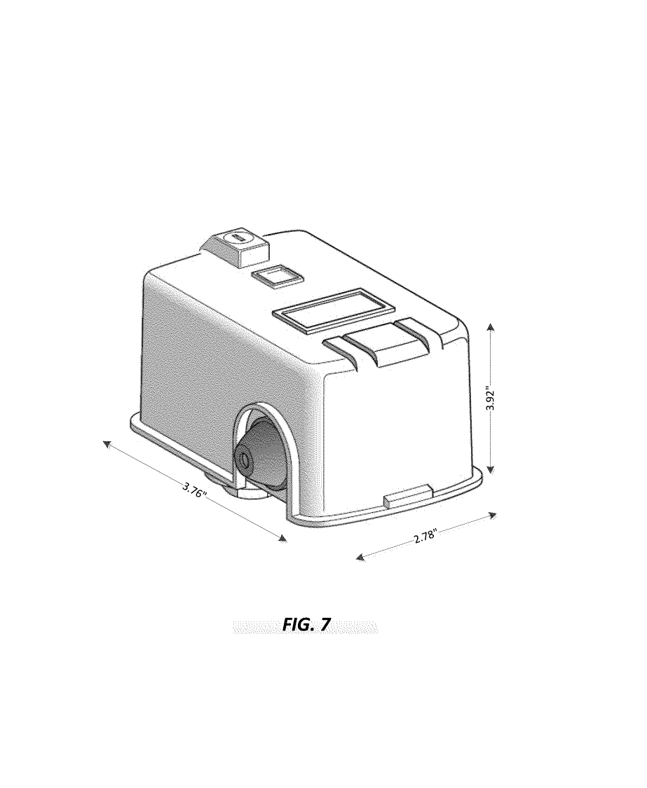

The pressure switch herein which may be configured to provide water detection and the ability to shut-off power to the well pump may include, but is not limited to, pressure switches available from Mercoid Coroporation, Indiana, such as the Series CXA water pump pressure switches. Such a pressure switch and its associated dimensions in inches with mm shown in parenthesis are illustrated in FIG. 6. Such pressure switches will operate over a range of pressures from 15-150 psi. In addition, other commercially available pressure switches that may be employed herein includes those made available from Schneider Electric such as the “Square D PUMPTROL” brand pressure switch, Hubble Industrial Controls—Archdale N.C., Lofoo Ind. Co.—China and Maker Electric—China. See FIG. 7. Such pressure switches typically have a width of 2.78 inches, a height of 3.92 inches and a depth of 3.76 inches. This defines a volume of about 41 cubic inches. As noted above, the present invention allows for the incorporation of water leak detection such that the housing for such pressure switch may increase the volume 100% or to about 82 cubic inches, and more preferably increases the volume 50% to at most 62 cubic inches. However, it is again worth emphasizing that this is only one particular example and the present invention herein is not limited to such particular pressure switch configurations.

Expanding upon the above, the present invention therefore preferably applies to pressure switches that may define an original housing volume of about 30-45 cubic inches. Such original housing value has now been found to accommodate the incorporation of an automatic power shut-off mechanism which, based upon detection by one or a plurality of water leak sensors and /or a signal from a house alarm or wireless device that provides automatic shut-off to the well pump. The housing volume therefore need only be increased by a modest amount as described herein. In this preferred description of the present invention, where one, e.g., starts with an original housing volume of about 30-45 cubic inches, the housing volume need only be increased up to a maximum of 60-90 cubic inches (100% increase in volume), and more preferably, only up to a maximum of 45-67.4 cubic inches (50% increase in original volume). For example, if one starts with a housing volume of about 30 cubic inches, and one increases such housing volume by 50%, and up to about 45 cubic inches, one can readily incorporate the above described solenoid and lift bar and requisite electrical connections to provide power shut-down of the well pump upon detection of a water leak and/or a signal form a house alarm or wireless device.

It is readily apparent that variations of the present invention are within the reach and capabilities of those skilled in the art without departing from the scope of the invention as claimed.

1. A method for configuring a water pump pressure switch to provide for water leak detection and shut down of a water well pump comprising:
supplying a water pump pressure switch which is configured to allow for electrical power to be delivered to said water well pump as a function of a preset pressure limit wherein said pressure switch has an original housing volume (Vo);
incorporating a water leak detection system into said water pump pressure switch wherein the leak detection system responds to water detection and provides shut-down of said water well pump wherein said original housing volume (Vo) is increased to a housing volume maximum of equal to or less than 2(Vo) to accommodate said leak detection system.

2. The method of claim 1 wherein said increase of said original housing volume (Vo) is increased to a maximum of less than or equal to 1.6(Vo).

3. The method of claim 1 wherein said increase of said original housing volume (Vo) is increased in the range of 1.15(Vo) to 1.60(Vo).

4. The method of claim 1 wherein said water pump pressure switch includes electrical contacts which in a closed position are configured to provide electrical power to said water well pump and in an open position are configured to prevent electrical power from being delivered to said water well pump.

5. The method of claim 3 wherein said leak detection system comprises an electromechanical servo in communication with a lift bar which servo is capable of activating said lift bar which then engages and opens said electrical contacts.

6. The method of claim 1 wherein said leak detection system includes one or a plurality of water detectors which provide a signal to said pressure switch to shut-down said water well pump.

7. The method of claim 1 wherein said water leak detection system is capable of receiving a separate signal from an external alarm or wireless device to provide shut-down of said water well pump.

8. A leak detection system for a well pump comprising:
a well pump pressure switch having a housing containing electrical contacts which in a closed position are configured to provide for delivery of electrical power to said well pump and in an open position are configured to prevent electrical power from being delivered to said well pump;
one or a plurality of water detectors capable of providing a signal upon detection of water;
an electromechanical servo within said housing and in communication with said one or more of said water detectors;
a lift bar engaged with said electromechanical servo within said housing wherein said electromechanical servo is capable of activating said lift bar to engage and open said electrical contacts upon receipt of a signal from said one or more water detectors.

9. The leak detection system of claim 8 wherein said electromechanical servo is capable of activating said lift bar to engage and open said electric contact upon receipt of a signal from a house alarm or wireless device.

10. A water pump pressure switch for a well pump configured to respond to a signal from one or more water detectors comprising:
a housing containing electrical contacts which in a closed position are configured to provide for delivery of electrical power to said well pump and in an open position are configured to prevent electrical power from being delivered to said well pump;
a lift bar capable of opening and closing said electrical contacts:
an electromechanical servo engaged to said lift bar wherein said electromechanical servo is capable of activating said lift bar to engage and open said electrical contacts upon receipt of a signal from said one or more water detectors.

11. The water pump pressure switch of claim 10, wherein said electromechanical servo is capable of activating said lift bar to engage and open said electric contact upon receipt of a signal from a house alarm or wireless device.
